(19) United States
(12) Patent Application Publication
(10) Pub. No.: US 2024/0178418 A1
(43) Pub. Date: May 30, 2024

(54) METHOD FOR OPERATING A FUEL CELL SYSTEM, AND FUEL CELL SYSTEM

(71) Applicant: Robert Bosch GmbH, Stuttgart (DE)

(72) Inventor: Helerson Kemmer, Vaihingen (DE)

(21) Appl. No.: 18/552,471

(22) PCT Filed: Mar. 10, 2022
(86) PCT No.: PCT/EP2022/056175

§ 371 Date: Sep. 26, 2023

(30) Foreign Application Priority Data
Mar. 29, 2021 (DE) 10 2021 203 106.4

(51) Int. Cl. H01M 8/04223; H01M 8/04007; H01M 8/04014; H01M 8/04029; H01M 8/04225

(52) U.S. Cl. CPC H01M 8/04253; H01M 8/04014; H01M 8/04029; H01M 8/04074; H01M 8/04225

(57) ABSTRACT

The invention relates to a method for operating a fuel cell system (1), in which air is supplied to a fuel cell stack (2) via an air intake path (3) and outgoing air emerging from the fuel cell stack (2) is removed via an outgoing air path (4), and in which a coolant of a cooling circuit (5) is conducted through the fuel cell stack (2) in order to remove the waste heat. According to the invention, in a starting situation, in particular when starting the fuel cell system (1) at freezing temperatures, the coolant is heated using at least one heat exchanger (6, 7) prior to entering the fuel cell stack (2), wherein the outgoing air emerging from the fuel cell stack (2) is used as a heat source.

The invention further relates to a fuel cell system (1) for carrying out the method.

### BACKGROUND

The invention relates to a method for operating a fuel cell system. The invention further relates to a fuel cell system suitable for performing the method according to the invention or for operation according to the method.

Hydrogen-based fuel cells convert hydrogen and oxygen into electrical energy, waste heat, and water. As a rule, air taken from the environment serves as the oxygen supplier. To increase electrical power, a plurality of fuel cells are typically grouped together to form a fuel cell stack, which is also referred to as a “stack”. The latter is permeated by multiple supply channels in order to supply the individual fuel cells with the required reaction gases. Moreover, the fuel cell stack comprises cooling passages that are exposed to the coolant of a cooling circuit. The coolant is used to remove the waste heat generated by the electrochemical reaction in the fuel cells. The further accumulating water is discharged via further passages that permeate the fuel cell stack.

When starting a fuel cell system, especially at temperatures below 0° C., the fuel cell stack must first be heated. Heating up as quickly as possible ensures that no water and/or ice build-up that would hinder or even completely prevent the start-up process is able to form. However, the icing hazard is not eliminated until the coolant that was introduced into the fuel cell stack reaches a temperature above 0° C. The coolant is therefore heated when starting at freezing temperatures, either externally to the stack or by an electrochemical reaction in the stack. However, both result in the startup process being drawn out. Furthermore, due to constant cooling below 0° C., the ice tolerance of the fuel cells must be increased, for example by installing ice buffers. Alternatively or in addition, heaters can be provided in the system. However, this will result in additional costs.

### SUMMARY

The object of the present invention is to therefore improve the freeze-start capability of a fuel cell system as far as possible without additional thermal power in the form of heaters. At the same time, costs are to be saved.

Proposed in order to achieved said object are the method according to the disclosure and the fuel cell system according to the disclosure.

The invention relates to a method for operating a fuel cell system, in which air is supplied to a fuel cell stack via an air intake path, and outgoing air emerging from the fuel cell stack is removed via an outgoing air path. Furthermore, in the method, a coolant of a cooling circuit is conducted through the fuel cell stack in order to remove the waste heat. According to the invention, in a starting situation, in particular when starting the fuel cell system at freezing temperatures, the coolant is heated using at least one heat exchanger before entering the fuel cell stack, whereby the outgoing air exiting the fuel cell stack is used as a heat source.

Utilizing the heat of the outgoing air exiting the fuel cell stack or the outgoing enthalpy eliminates the need for heaters in the system. The coolant can therefore be heated without additional thermal power prior to entering the fuel cell. Furthermore, measures that serve to increase ice tolerance, such as the use of ice buffers in the fuel cells, can be reduced. All of this reduces costs. In addition, a fast start at freezing temperatures can be performed, since the coolant flow rate does not have to be reduced—as is usually the case—to prevent the fuel cells from freezing in the inlet area. A quick start, in turn, reduces hydrogen consumption, which also has a cost-cutting effect.

According to a first preferred embodiment of the invention, a heat exchanger arranged in the cooling circuit is used to heat the coolant. In a starting situation, particularly a start at freezing temperatures, the outgoing air emerging from the fuel cell stack then bypasses into the heat exchanger by way of at least one valve integrated into the outgoing air path. In situations where heating of the coolant is not required, the valve integrated into the outgoing air path can remain open, so outgoing air does not bypass into the heat exchanger. In order to prevent a return flow of outgoing air from the outgoing air path into the heat exchanger, a further valve arranged in the bypass route of the outgoing air path can be provided. This valve is then closed.

The heat exchanger integrated into the cooling circuit can in particular be a gas-water heat exchanger, since the outgoing air is a gas and the coolant of the cooling circuit is preferably water. Preferably, the heat exchanger is designed as a counter-current heat exchanger. However, a cross-flow heat exchanger design is also possible.

According to a second preferred embodiment of the invention, a heat exchanger arranged in the outgoing air path is used to heat the coolant. In a starting situation, particularly a start at freezing temperatures, the coolant then bypasses into the heat exchanger by way of at least one valve integrated into the cooling circuit. In this case as well, the coolant in the heat exchanger is conducted past the outgoing air, so the heat exchanger can in particular be a gas-water heat exchanger. Preferably, the heat exchanger is designed as a counter-current heat exchanger. However, the use of a cross-flow heat exchanger is also possible.

According to a third preferred embodiment of the invention, a heat exchanger arranged in the cooling circuit and a heat exchanger arranged in the outgoing air path are used. Depending on the switch position, at least one valve is connected or connectable via a further cooling circuit. In other words, the coolant is not directly heated by the outgoing air, but indirectly via the coolant of the further cooling circuit. The further cooling circuit can in particular consist of a cooling circuit that, during normal operation of the system, is used to control the air temperature on the inlet side of the fuel cell stack. Regarding a corresponding switching process, the further cooling circuit can then be used to heat the coolant of the first cooling circuit in a starting situation, in particular when starting the system at freezing temperature. Suitable switching can be achieved using valves, e.g., 3-way and/or 4-way valves.

The heat exchanger integrated into the cooling circuit or into the two cooling circuits is preferably a water-water heat exchanger. In the present case, the heat exchanger integrated into the outgoing air path is a gas-water heat exchanger. The heat exchangers can each be designed as counter-flow or cross-flow heat exchangers.

The further proposed fuel cell system comprises a fuel cell stack, an air intake path, via which air can be supplied to the fuel cell stack, and an outgoing air path, via which outgoing air emerging from the fuel cell stack can be removed. The fuel cell system further comprises a cooling circuit that contains a coolant for dissipating the waste heat from the fuel cell stack. According to the invention, a heat exchanger is integrated into the outgoing air path or into a switchable secondary outgoing air path, by way of which the cooling circuit, a switchable extension of the cooling circuit, or another cooling circuit is connected to the first cooling circuit via a further heat exchanger in a heat transmitting manner.

The proposed fuel cell system therefore comprises all the components needed to perform the method according to the invention described hereinabove. In other words, the proposed fuel cell system is operable according to the inventive method described hereinabove. The same benefits can therefore be achieved. In particular, a rapid start at freezing temperatures can be achieved without the use of additional heaters. Measures that are designed to increase the ice tolerance of the system can be reduced or even eliminated. Costs are correspondingly decreased. At the same time, hydrogen consumption can be reduced.

The advantages are achieved by the fact that, in a starting situation, in particular when starting the system at freezing temperatures, the warm outgoing air emerging from the fuel cell stack can be used to heat the coolant of the cooling circuit. Depending on the specific design of the fuel cell system, the heat from the outgoing air is either transferred directly to the coolant of the cooling circuit, or transferred indirectly via the coolant of another cooling circuit. If the heat is transferred directly, the heat exchanger provided for this purpose can be integrated into the cooling circuit or into the outgoing air path. If another cooling circuit is connected in between, then at least two heat exchangers are provided.

According to one preferred embodiment of the invention, a valve is integrated into the outgoing air path, by way of which valve the secondary outgoing air path is connectable. In other words, upon opening the valve, the warm outgoing air emerging from the fuel cell stack is conducted into the secondary outgoing air path. Via this path, the outgoing air can then be supplied to a heat exchanger integrated into the cooling circuit. Downstream of the heat exchanger, the outgoing air from the secondary outgoing air path can then be introduced back into the outgoing air path. Advantageously, a further valve, in particular a shut-off valve, is integrated into the secondary outgoing air path to prevent a rearward flow of outgoing air into the heat exchanger.

According to a further preferred embodiment of the invention, a valve is integrated into the first cooling circuit, by means of which the extension of the cooling circuit can be switched on. When the valve is opened, the cooling circuit can thereby be extended, and the coolant can be supplied to a heat exchanger integrated into the outgoing air path. Bypassing of the outgoing air flow can be omitted thereby. Furthermore, the extended cooling circuit can be used to control the air temperature on the inlet side of the fuel cell stack, if suitably connected. The extension of the cooling circuit can thus replace a further cooling circuit for controlling the air temperature on the inlet side of the fuel cell stack, which has the advantage that only one coolant pump is required to convey the coolant.

It is further proposed that at least one valve be integrated into the extension of the cooling circuit, or into the further cooling circuit in order to bypass the heat exchanger integrated into the outgoing air path. By bypassing the heat exchanger integrated into the outgoing air path, heating of the coolant by the outgoing air can be avoided during normal operation of the system, so the cooling effect of the coolant is increased. This is particularly advantageous when the coolant is also used to control the air temperature on the inlet side of the fuel cell stack, which can then be cooled more efficiently using the coolant.

In order to use the coolant of the first cooling circuit or of the further cooling circuit to control the air temperature on the inlet side of the fuel cell stack, it is further proposed that—depending on the switch position of the at least one valve to bypass the heat exchanger integrated into the outgoing air path—the extension of the cooling circuit or the further cooling circuit by means of at least one heat exchanger integrated into the air intake path enables air temperature control.

### BRIEF DESCRIPTION OF THE DRAWINGS

Preferred embodiments of the invention are described in greater detail hereinafter with reference to the accompanying drawings. Shown are:

FIG. 1 a schematic representation of the cathode area of a first fuel cell system according to the invention,

FIG. 2 a schematic representation of the cathode area of a second fuel cell system according to the invention; and

FIG. 3 a schematic representation of the cathode area of a third fuel cell system according to the invention.

### DETAILED DESCRIPTION

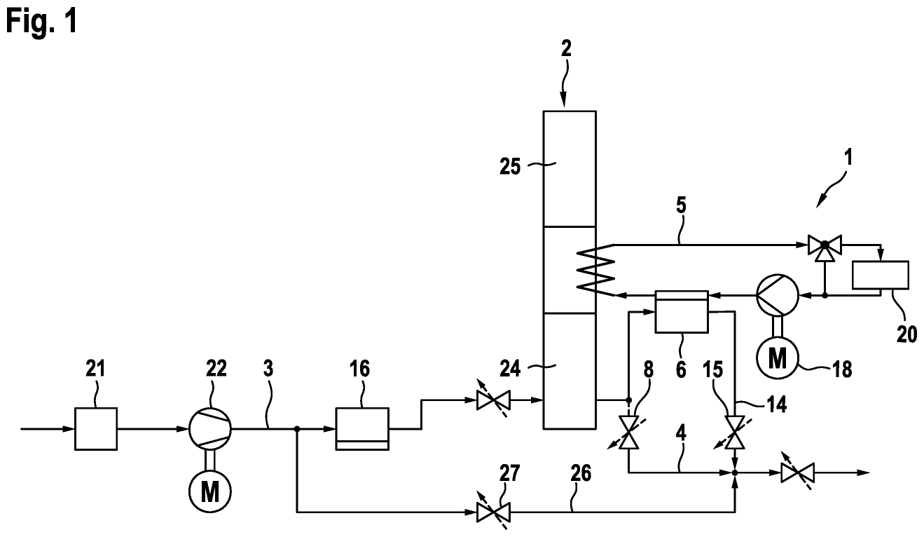

FIG. 1 shows a fuel cell stack 2 of a fuel cell system 1 according to the invention, comprising a cathode 24 and an anode 25. In operation of the fuel cell system 1, the anode 25 is supplied with hydrogen via an anode circuit (not shown) which, together with oxygen, is converted into electrical energy, waste heat and water. The oxygen delivery agent is air removed from the environment and supplied to the cathode 24 via an air intake path 3. The air drawn from the environment is first supplied to an air filter 21 integrated into the air intake path 3, then compressed using an air compressor 22. Since the air heats up strongly during compression, it is cooled before entering the fuel cell stack 2. A heat exchanger 16 is arranged in the air intake path 3 for this purpose. The air, or rather outgoing air, exiting the fuel cell stack 2 is discharged via an outgoing air path 4. To bypass the fuel cell stack 2, the air intake path 3 and the outgoing air path 4 can be connected via a bypass path 26 by way of an integrated bypass valve 27.

The fuel cell stack 2 is connected to a cooling circuit 5 to dissipate the heat to a vehicle radiator 20. A coolant pump 18 for conveying a coolant, e.g. water, is integrated into the cooling circuit 5. In addition, a heat exchanger 6 is arranged in the cooling circuit 5, and an secondary outgoing air path 14 furthermore leads through said circuit. By closing a valve 8 integrated into the outgoing air path 4, the warm outgoing air exiting the fuel cell stack 2 can bypass into the secondary outgoing air path 14 so that said air passes through the heat exchanger 6. Downstream of the heat exchanger 6, the outgoing air is then again introduced to the outgoing air path 4. In order to prevent outgoing air from flowing back into the heat exchanger 6, another valve 15 is provided in the secondary outgoing air path 14, which valve is then closed.

In a starting situation, in particular starting the system at freezing temperatures, the valve 8 is closed and the valve 15 is opened. The warm outgoing air emerging from the fuel cell stack 2 then flows through the heat exchanger 6 via the secondary outgoing air path 14, thereby heating the coolant of the cooling circuit 5. Therefore, heated coolant can be supplied to the fuel cell stack 2 so that the system starts up faster.

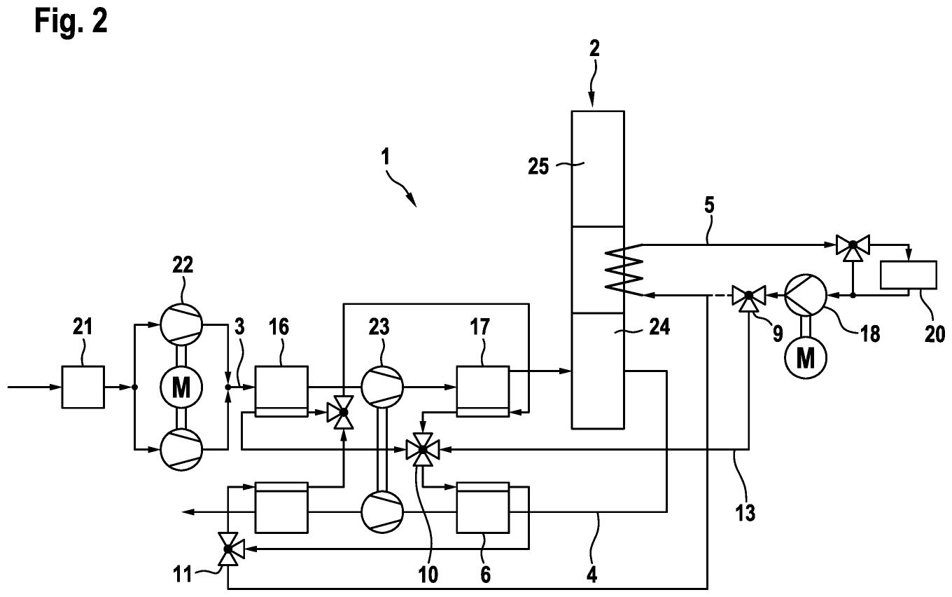

FIG. 2 shows the cathode area of a further fuel cell system 1 according to the invention. The air supplied to the fuel cell stack 2 via the air intake path 3 is in this case compressed in multiple stages. A first air compressor 22 and a second air compressor 23 are integrated into the air intake path 3 for this purpose. To cool the air after each compression operation, heat exchangers 16, 17 are placed downstream of each of the air compressors 22, 23. The coolant of the cooling circuit 5 flows through them, and is also used to cool the fuel cell stack 2. For this purpose, the cooling circuit 5 comprises an extension 13 which can be switched on depending on the switching position of a valve 9. In the extension 13, a valve 10 and a valve 11 are furthermore provided. Depending on the switch position of these two valves 10, 11, the coolant can be conducted through a heat exchanger 6 integrated into the outgoing air path 4 instead of the heat exchanger 16, 17 integrated into the air intake path 3. When starting the system at freezing temperatures, the coolant of the cooling circuit 5 can be heated by means of the warm outgoing air in the outgoing air path 4 before it is introduced into the fuel cell stack 2.

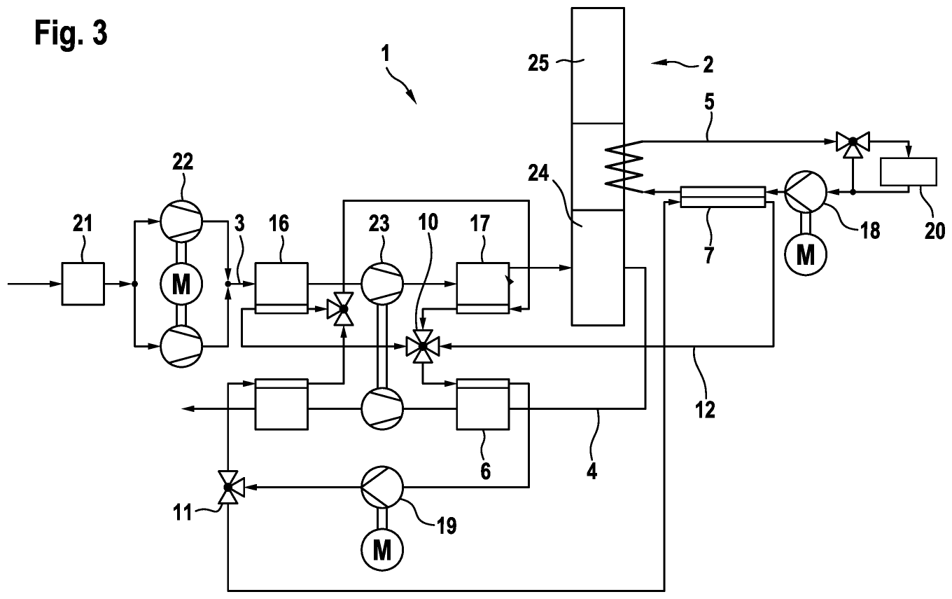

A modification of the system in FIG. 2 is shown in FIG. 3. The air in the air intake path 3 is in this case also compressed in multiple stages, so a first air compressor 22 and a second air compressor 23 are integrated into the air intake path 3. Downstream of each air compressor 22, 23, a heat exchanger 16, 17 is again provided. However, the coolant of the cooling circuit 5 does not flow through these heat exchangers. Instead, the coolant of a further cooling circuit 12 flows through them. A further coolant pump 19 for conveying the coolant is therefore provided in the cooling circuit 12. In order to heat the coolant of the cooling circuit 5 using outgoing air enthalpy in a starting situation, in particular at freezing temperatures, a further heat exchanger 7 is integrated in the cooling circuit 5, through which the further cooling circuit 12 also passes. Valves 10, 11 are furthermore provided in the further cooling circuit 12 to allow the coolant of the further cooling circuit 12 to be diverted into a heat exchanger 6 integrated into the outgoing air path 4. The heat of the outgoing air therefore first heats the coolant of the cooling circuit 12, which then transfers the heat in the heat exchanger 7 to the coolant of the cooling circuit 5. The outgoing enthalpy can therefore also be used to heat the coolant as needed in this case.

1. A method for operating a fuel cell system (1), in which air is supplied to a fuel cell stack (2) via an air intake path (3) and outgoing air emerging from the fuel cell stack (2) is discharged via an outgoing air path (4), and in which a coolant of a cooling circuit (5) is conducted through the fuel cell stack (2) in order to dissipate waste heat,
wherein in a starting situation, the coolant is heated using at least one heat exchanger (6, 7) before entering the fuel cell stack (2), wherein the outgoing air emerging from the fuel cell stack (2) is used as a heat source.

2. The method according to claim 1,
wherein a heat exchanger (6) is arranged in the cooling circuit (5) and, in a starting situation, the outgoing air emerging from the fuel cell stack (2) bypasses into the heat exchanger (6) by way of at least one valve (8) integrated into the outgoing air path (4).

3. The method according to claim 1,
wherein a heat exchanger (6) is used and, in a starting situation the coolant bypasses into the heat exchanger (6) by way of at least one valve (9) integrated into the cooling circuit (5).

4. The method according to claim 1,
wherein a heat exchanger (7) arranged in the cooling circuit (5) and a heat exchanger (6) arranged in the outgoing air path (4) are used, wherein these heat exchangers are connected or can be connected via a further cooling circuit (12) depending upon a switching position of at least one valve (10, 11).

5. A fuel cell system (1) comprising a fuel cell stack (2), an air intake path (3), via which air can be supplied to the fuel cell stack (2), and an outgoing air path (4), via which outgoing air emerging from the fuel cell stack (2) can be removed, and further comprising a cooling circuit (5) which carries a coolant for discharging waste heat from the fuel cell stack (2),
wherein a heat exchanger (6) is integrated into the outgoing air path (4) or a connectable secondary outgoing air path (14), via which the cooling circuit (5), a connectable extension (13) of the cooling circuit (5), or a further cooling circuit (12) is guided, said heat exchanger being connected to the cooling circuit (5) via a further heat exchanger (7) in a heat transmitting manner.

6. The fuel cell system (1) according to claim 5,
wherein a valve (8) is integrated into the outgoing air path (4), by means of which valve the secondary outgoing air path (14) connectable, and wherein a further valve (15) is integrated into the secondary outgoing air path (14).

7. The fuel cell system (1) according to claim 5,
wherein a valve (9) is integrated into the cooling circuit (5), by means of which valve (9) the extension (13) can be connected.

8. The fuel cell system (1) according to claim 5,
wherein at least one valve (10, 11) is integrated into the extension (13) of the cooling circuit (5), or into the further cooling circuit (12), in order to bypass the heat exchanger (6) integrated into the outgoing air path (4).

9. The fuel cell system (1) according to claim 8,
wherein, depending on a switching position of the at least one valve (10, 11), the extension (13) of the cooling circuit (5) or the further cooling circuit (12) leads through at least one heat exchanger (16, 17) integrated into the air intake path (3) for air temperature control.

10. The method according to claim 1, wherein the starting situation includes starting the fuel cell system at freezing temperatures (1).

11. The method according to claim 2, wherein the heat exchanger (6) is a gas-water heat exchanger.

12. The method according to claim 3, wherein the heat exchanger (6) is a gas-water heat exchanger arranged in the outgoing air path (4).

13. The method according to claim 4, wherein the heat exchanger (7) arranged in the cooling circuit (5) is a water-water heat exchanger.

14. The fuel cell system (1) according to claim 6, wherein the further valve (15) is a shut-off valve.
